(19) United States
(12) Patent Application Publication
(10) Pub. No.: US 2012/0249705 A1
(43) Pub. Date: Oct. 4, 2012

(54) INK JET RECORDING METHOD

(75) Inventors: Katsuko Aoki, Kiso (JP); Hiroshi Mukai, Shiojiri-shi (JP)

(73) Assignee: Seiko Epson Corporation, Tokyo (JP)

(21) Appl. No.: 13/435,122

(22) Filed: Mar. 30, 2012

(30) Foreign Application Priority Data
Mar. 30, 2011 (JP) 2011-075933

(51) Int. Cl. B41J 2/01; C09D 11/12

(52) U.S. Cl. 347/102; 347/105; 524/556

(57) ABSTRACT

An ink jet recording method includes heating an ink non-absorbent or low ink-absorbing recording medium to a temperature of 40° C. to 110° C. and performing recording using an aqueous ink composition containing a water-insoluble colorant, a paraffin wax, resin particles, and water.

Priority is claimed under 35 U.S.C. §119 to Japanese Application No. 2011-075933 filed on Mar. 30, 2011, is hereby incorporated by reference in its entirety.

### BACKGROUND

1. Technical Field

The present invention relates to a printing method using an ink jet recording technique.

2. Related Art

A printing method using an ink jet recording technique is performed in such a manner that droplets of ink are applied to a recording medium such as paper by ejecting the ink droplets. Since the ink jet recording technique has been greatly advanced in recent years, the printing method using the ink jet recording technique has been used for high-density image recording (image printing), for which photography and offset printing have been conventionally used. Therefore, not only plain paper and ink jet paper (matte or glossy paper) commonly used but also ink non-absorbent or low ink-absorbing recording media such as printing paper, synthetic paper, and films need to provide high-quality prints.

Various ink compositions useful in obtaining high-quality images printed on sheets of plain paper or ink jet paper have been proposed. For example, JP-A-2009-235155 (hereinafter referred to as Patent Document 1) discloses an ink composition containing a pigment coated with an insoluble polymer, specific glycol ethers, and 1,2-alkyldiols. JP-A-2002-80761 discloses a recording solution, for ink printers, containing a colorant, two or more types of resin particles, wax, and water. The recording solution has a high resin solid content for the purpose of improving the impregnation of plain paper with the recording solution, the permeation of recording solution into plain paper, and the water resistance of plain paper by increasing the density of images.

In recent years, aqueous inks have been used to record images on film recording media such as polyvinyl chloride bases, that is, ink non-absorbent recording media instead of solvent pigment inks from the viewpoint of safety and environmental protection. In particular, the following method has been proposed as an example of such an aqueous ink: a method for printing an image on a hydrophobic surface using ink containing water, a glycol solvent, an insoluble colorant, a polymeric dispersant, a silicone surfactant, a fluorinated surfactant, a water-insoluble graft copolymer binder, and N-methylpyrrolidone (see JP-A-2000-44858). Furthermore, the following ink has been proposed: a polymer colloid-containing aqueous ink-jet ink, containing an aqueous liquid vehicle containing a volatile co-solvent with a boiling point of 285° C. or lower, acid-functionalized polymer colloid particulates, and a pigment colorant, for printing an image on a non-porous substrate (see JP-A-2005-220352).

However, print images formed on recording media using conventional aqueous inks have insufficient abrasion resistance. Therefore, a method for recording a print image having higher durability and abrasion resistance has been required.

In order to cope with such a requirement, for example, JP-A-2004-195451 discloses a liquid composition (overcoat composition) that is applied to an print image for the purpose of imparting high durability to the print image. The liquid composition contains an aqueous carrier, a humectant, a surfactant, an addition polymer with an acid value of more than 110. The application of the liquid composition to a printed image allows the surface of the image to be protected and imparts high durability to the image. Patent Document 1 further discloses a printing method including a step of applying an overcoat composition prepared by removing a colorant from an ink composition.

Since ink non-absorbent and low ink-absorbing recording media include no ink-absorbing layers, any ink or overcoat composition does not permeate the recording media or cannot be sufficiently fixed to surfaces of the recording media. Even in the case of applying an overcoat composition to the recording media, there is a problem in that printed images are separated from the recording media.

### SUMMARY

An advantage of some aspects of the invention is to provide an ink jet recording method capable of forming an image having excellent abrasion resistance on an ink non-absorbent or low ink-absorbing recording medium.

(1) An ink jet recording method includes heating an ink non-absorbent or low ink-absorbing recording medium to a temperature of 40° C. to 110° C. and performing recording using an aqueous ink composition containing a water-insoluble colorant, a paraffin wax, resin particles, and water.

(2) In the ink jet recording method specified in Item (1), the paraffin wax has an average particle size of 5 nm to 400 nm.

(3) In the ink jet recording method specified in Item (1) or (2), the paraffin wax has a melting point of 110° C. or lower.

(4) In the ink jet recording method specified in any one of Items (1) to (3), the content of the paraffin wax in the aqueous ink composition is 0.1% to 3% by mass.

(5) In the ink jet recording method specified in any one of Items (1) to (4), the recording medium is made of polyvinyl chloride.

(6) In the ink jet recording method specified in any one of Items (1) to (5), the aqueous ink composition further contains a polyethylene wax.

(7) In the ink jet recording method specified in any one of Items (1) to (6), the aqueous ink composition is substantially free of an alkanepolyol with a boiling point of 280° C. or higher at 1 atm.

(8) An ink composition is one used in the ink jet recording method specified in any one of Items (1) to (7).

(9) A record is one recorded by the ink jet recording method specified in any one of Items (1) to (7).

According to an ink jet recording method, an image having excellent abrasion resistance can be formed on an ink non-absorbent or low ink-absorbing recording media.

### DESCRIPTION OF EXEMPLARY EMBODIMENTS

Preferred embodiments of the invention will now be described in detail.

### 1. Aqueous Ink Composition

An aqueous ink composition used in an ink jet recording method according to an embodiment of the invention contains a water-insoluble colorant, a paraffin wax, resin particles, and water. These components are described below in detail.

### 1.1 Water-Insoluble Colorant

The aqueous ink composition, which used in the ink jet recording method, contains the water-insoluble colorant. Examples of the water-insoluble colorant include water-insoluble dyes and pigments. The water-insoluble colorant is preferably a pigment. The pigment is insoluble or sparingly soluble in water and is unlikely to be discolored by light or gas. Therefore, a print printed with an ink composition containing the pigment is excellent in water resistance, gas resistance, and light resistance and has good storage stability.

The pigment may be a known inorganic pigment, an organic pigment, or carbon black. In particular, the organic pigment and carbon black are preferred because the organic pigment and carbon black exhibit good color development, have low density, and therefore are unlikely to settle during dispersion.

Preferred examples of the carbon black used herein include furnace black; lamp black; acetylene black; channel black such as C.I. Pigment Black 7; commercial products, such as Carbon Black No. 2300, Carbon Black No. 900, Carbon Black MCF 88, Carbon Black No. 20B, Carbon Black No. 33, Carbon Black No. 40, Carbon Black No. 45, Carbon Black No. 52, Carbon Black MA 7, Carbon Black MA 8, Carbon Black MA 100, and Carbon Black No. 2200B, available from Mitsubishi Chemical Corporation; commercial products, such as Color Black FW 1, Color Black FW 2, Color Black FW 2V, Color Black FW 18, Color Black FW 200, Color Black S 150, Color Black S 160, Color Black S 170, Printex 35, Printex U, Printex V, Printex 140U, Special Black 6, Special Black 5, Special Black 4A, Special Black 4, and Special Black 250, available from Degussa; commercial products, such as Conductex SC, Raven 1255, Raven 5750, Raven 5250, Raven 5000, Raven 3500, Raven 1255, and Raven 700, available from Colombian Carbon; and commercial products, such as Regal 400R, Regal 330R, Regal 660R, Mogul L, Monarch 700, Monarch 800, Monarch 880, Monarch 900, Monarch 1000, Monarch 1100, Monarch 1300, Monarch 1400, and Elftex 12 available from Cabot. These carbon blacks are examples suitable for the invention. The invention is not limited to these carbon blacks. These carbon blacks may be used alone or in combination. The content of the carbon black in the aqueous ink composition is preferably 0.1% to 20% by mass and more preferably 0.5% to 10% by mass.

Preferred examples of the organic pigment include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments.

Other examples of the organic pigment, which is used in the aqueous ink composition used in the ink jet recording method according to the invention, include pigments below.

Examples of a pigment used in a cyan ink composition include C. I. Pigment Blue 1, Pigment Blue 2, Pigment Blue 3, Pigment Blue 15, Pigment Blue 15:1, Pigment Blue 15:2, Pigment Blue 15:3, Pigment Blue 15:4, Pigment Blue 15:6, Pigment Blue 15:34, Pigment Blue 16, Pigment Blue 18, Pigment Blue 22, Pigment Blue 60, Pigment Blue 65, Pigment Blue 66, Pigment Vat Blue 4, and Pigment Vat Blue 60. Pigment Blue 15:3 and Pigment Blue 15:4 are preferred. These pigments may be used alone or in combination. The content of the pigment in the cyan ink composition is preferably about 0.1% to 20% by mass and more preferably about 0.5% to 10% by mass.

Examples of a pigment used in a magenta ink composition include C. I. Pigment Red 1, C. I. Pigment Red 2, C. I. Pigment Red 3, C. I. Pigment Red 4, C. I. Pigment Red 5, C. I. Pigment Red 6, C. I. Pigment Red 7, C. I. Pigment Red 8, C. I. Pigment Red 9, C. I. Pigment Red 10, C. I. Pigment Red 11, C. I. Pigment Red 12, C. I. Pigment Red 14, C. I. Pigment Red 15, C. I. Pigment Red 16, C. I. Pigment Red 17, C. I. Pigment Red 18, C. I. Pigment Red 19, C. I. Pigment Red 21, C. I. Pigment Red 22, C. I. Pigment Red 23, C. I. Pigment Red 30, C. I. Pigment Red 31, C. I. Pigment Red 32, C. I. Pigment Red 37, C. I. Pigment Red 38, C. I. Pigment Red 40, C. I. Pigment Red 41, C. I. Pigment Red 42, C. I. Pigment Red 48 (Ca), C. I. Pigment Red 48 (Mn), C. I. Pigment Red 57 (Ca), C. I. Pigment Red 57:1, C. I. Pigment Red 88, C. I. Pigment Red 112, C. I. Pigment Red 114, C. I. Pigment Red 122, C. I. Pigment Red 123, C. I. Pigment Red 144, C. I. Pigment Red 146, C. I. Pigment Red 149, C. I. Pigment Red 150, C. I. Pigment Red 166, C. I. Pigment Red 168, C. I. Pigment Red 170, C. I. Pigment Red 171, C. I. Pigment Red 175, C. I. Pigment Red 176, C. I. Pigment Red 177, C. I. Pigment Red 178, C. I. Pigment Red 179, C. I. Pigment Red 184, C. I. Pigment Red 185, C. I. Pigment Red 187, C. I. Pigment Red 202, C. I. Pigment Red 209, C. I. Pigment Red 219, C. I. Pigment Red 224, C. I. Pigment Red 245, C. I. Pigment Red 254, C. I. Pigment Red 264, C. I. Pigment Violet 19, C. I. Pigment Violet 23, C. I. Pigment Violet 32, C. I. Pigment Violet 33, C. I. Pigment Violet 36, C. I. Pigment Violet 38, C. I. Pigment Violet 43, and C. I. Pigment Violet 50. C. I. Pigment Red 112, C. I. Pigment Red 202, and C. I. Pigment Violet 19 are preferred. These pigments may be used alone or in combination. The content of the pigment in the magenta ink composition is preferably about 0.1% to 20% by mass and more preferably about 0.5% to 10% by mass.

Examples of a pigment used in a yellow ink composition include C. I. Pigment Yellow 1, C. I. Pigment Yellow 2, C. I. Pigment Yellow 3, C. I. Pigment Yellow 4, C. I. Pigment Yellow 5, C. I. Pigment Yellow 6, C. I. Pigment Yellow 7, C. I. Pigment Yellow 10, C. I. Pigment Yellow 11, C. I. Pigment Yellow 12, C. I. Pigment Yellow 13, C. I. Pigment Yellow 14, C. I. Pigment Yellow 16, C. I. Pigment Yellow 17, C. I. Pigment Yellow 24, C. I. Pigment Yellow 34, C. I. Pigment Yellow 35, C. I. Pigment Yellow 37, C. I. Pigment Yellow 53, C. I. Pigment Yellow 55, C. I. Pigment Yellow 65, C. I. Pigment Yellow 73, C. I. Pigment Yellow 74, C. I. Pigment Yellow 75, C. I. Pigment Yellow 81, C. I. Pigment Yellow 83, C. I. Pigment Yellow 93, C. I. Pigment Yellow 94, C. I. Pigment Yellow 95, C. I. Pigment Yellow 97, C. I. Pigment Yellow 98, C. I. Pigment Yellow 99, C. I. Pigment Yellow 108, C. I. Pigment Yellow 109, C. I. Pigment Yellow 110, C. I. Pigment Yellow 113, C. I. Pigment Yellow 114, C. I. Pigment Yellow 117, C. I. Pigment Yellow 120, C. I. Pigment Yellow 124, C. I. Pigment Yellow 128, C. I. Pigment Yellow 129, C. I. Pigment Yellow 133, C. I. Pigment Yellow 138, C. I. Pigment Yellow 139, C. I. Pigment Yellow 147, C. I. Pigment Yellow 151, C. I. Pigment Yellow 153, C. I. Pigment Yellow 154, C. I. Pigment Yellow 155, C. I. Pigment Yellow 167, C. I. Pigment Yellow 172, C. I. Pigment Yellow 180, C. I. Pigment Yellow 185, and C. I. Pigment Yellow 213. C. I. Pigment Yellow 74, C. I. Pigment Yellow 155, and C. I. Pigment Yellow 213 are preferred. These pigments may be used alone or in combination. The content of the pigment in the yellow ink composition is about 0.1% to 20% by mass and more preferably about 0.5% to 10% by mass.

In order to use the pigment in the aqueous ink composition, the pigment needs to be stably dispersed in water. Examples of a technique for stably dispersing the pigment in water include a technique in which the pigment is treated with a resin dispersant containing a water-soluble resin and/or a water-dispersible resin so as to be dispersed in water (the pigment treated by this technique is hereinafter referred to as “resin-dispersed pigment”), a technique in which the pigment is treated with a water-soluble surfactant and/or a water-dispersible surfactant so as to be dispersed in water (the pigment treated by this technique is hereinafter referred to as “surfactant-dispersed pigment”), a technique in which hydrophilic functional groups are chemically or physically grafted to the surfaces of particles of the pigment such that the pigment particles can be dispersed and/or dissolved in water without using the resin or surfactant (the pigment treated by this technique is hereinafter referred to as “surface-treated pigment”). The aqueous ink composition may contain any one of the resin-dispersed pigment, the surfactant-dispersed pigment, and the surface-treated pigment or may contain some of the resin-dispersed pigment, the surfactant-dispersed pigment, and the surface-treated pigment as required. In particular, the resin-dispersed pigment is preferred because the resin-dispersed pigment increases the adhesion between a recording medium and the aqueous ink composition or a solid in the aqueous ink composition when the aqueous ink composition is attached to the recording medium. The surface-treated pigment is also preferred because the surface-treated pigment has high dispersion stability and enables the aqueous ink composition to have good storage stability.

Examples of the resin dispersant, which is used to prepare the resin-dispersed pigment, include polyvinyl alcohol, polyacrylic acid, acrylic acid-acrylonitrile copolymers, vinyl acetate-acrylic ester copolymers, acrylic acid-acrylic ester copolymers, styrene-acrylic acid copolymers, styrene-methacrylic acid copolymers, styrene-methacrylic acid-acrylic ester copolymers, styrene-α-methylstyrene-acrylic acid copolymers, styrene-α-methylstyrene-acrylic acid-acrylic ester copolymers, styrene-maleic acid copolymers, styrene-maleic anhydride copolymers, vinylnaphthalene-acrylic acid copolymers, vinylnaphthalene-maleic acid copolymers, vinyl acetate-maleic ester copolymers, vinyl acetate-crotonic acid copolymers, vinyl acetate-acrylic acid copolymers and salts of these copolymers. In particular, the following copolymers are performed: copolymers produced from monomers containing a hydrophobic functional group and monomers containing a hydrophilic functional group and copolymers produced from monomers containing a hydrophobic functional group and a hydrophilic functional group. These copolymers may be in the form of random copolymers, block copolymers, alternating copolymers, and graft copolymers.

The copolymer salts may be salts of basic compounds such as ammonia, ethylamine, diethylamine, triethylamine, propylamine, isopropylamine, dipropylamine, butylamine, isobutylamine, diethanolamine, triethanolamine, triisopropanolamine, aminomethylpropanolamine, and morpholine. The amount of each added basic compound is not particularly limited and may be equal to or more than the neutralization equivalent of the resin dispersant.

The resin dispersant preferably has a weight-average molecular weight of 1,000 to 100,000 and more preferably 3,000 to 10,000. When the molecular weight thereof is within the above range, the colorant can be stably dispersed in water and the viscosity of the aqueous ink composition can be suitably controlled.

The resin dispersant preferably has an acid value of 50 to 300 and more preferably 70 to 150. When the acid value thereof is within this range, the colorant can be stably dispersed in water and a print printed with the aqueous ink composition has good water resistance.

The resin dispersant may be a commercially available product, of which examples include Joncryl 67 (a weight-average molecular weight of 12,500 and an acid value of 213), Joncryl 678 (a weight-average molecular weight of 8,500 and an acid value of 215), Joncryl 586 (a weight-average molecular weight of 4,600 and an acid value of 108), Joncryl 611 (a weight-average molecular weight of 8,100 and an acid value of 53), Joncryl 680 (a weight-average molecular weight of 4,900 and an acid value of 215), Joncryl 682 (a weight-average molecular weight of 1,700 and an acid value of 238), Joncryl 683 (a weight-average molecular weight of 8,000 and an acid value of 160), and Joncryl 690 (a weight-average molecular weight of 16,500 and an acid value of 240) available from BASF Japan Ltd.

Examples of the surfactant used to prepare the surface-treated pigment include anionic surfactants such as salts of alkanesulfonic acids, salts of α-olefinsulfonic acids, salts of alkylbenzenesulfonic acids, salts of alkylnaphthalenesulfonic acids, salts of acylmethyltauric acid, salts of dialkylsulfosuccinic acids, salts of alkyl sulfates, salts of sulfonated olefins, salts of polyoxyethylene alkyl ether sulfates, salts of alkyl phosphates, salts of polyoxyethylene alkyl ether phosphates, and salts of monoglyceride phosphates; amphoteric surfactants such as alkylpyridinium salts, salts of alkylamino acids, alkyl dimethyl betaines; and nonionic surfactants such as polyoxyethylene alkyl ethers, polyoxyethylene alkyl phenyl ethers, polyoxyethylene alkyl esters, polyoxyethylene alkyl amides, glycerin alkyl esters, and sorbitan alkyl esters.

The amount of the resin dispersant or surfactant added to the pigment is preferably one to 100 parts and more preferably five to 50 parts per 100 parts of the pigment on a mass basis. When the amount thereof is within this range, the dispersion stability of the pigment in water can be secured.

The surface-treated pigment may contain a hydrophilic functional groups represented by the formula —OM, —COOM, —CO—, —SO₃M, —SO₂NH₂—, —RSO₂M, —PO₃HM, —PO₃M₂, —SO₂NHCOR, —NH₂, or —NR₂, wherein M represents a hydrogen atom, an alkali metal, an ammonium ion, or an organic ammonium ion and R represents an alkyl group containing one to 12 carbon atoms, a phenyl group which may have a substituent, or a naphthyl group which may have a substituent. The hydrophilic functional groups are chemically or physically grafted to the surfaces of the pigment particles directly or indirectly with polyvalent groups therebetween. The polyvalent groups may be alkylene groups containing one to 12 carbon atoms, phenylene groups which may have a substituent, or naphthylene groups which may have a substituent.

The surface-treated pigment is preferably one that has been surface-treated with a treatment agent containing sulfur such that —SO₃M and/or —RSO₂M groups are chemically bonded to the surfaces of the pigment particles, wherein M represents a counter ion such as a hydrogen ion, an alkali metal ion, an ammonium ion, or an organic ammonium ion. That is, the pigment is preferably surface-treated so as to be dispersible and/or soluble in water in such a manner that the pigment is dispersed in a solvent which contains no active proton, which has no reactivity with a sulfonic acid, and in which the pigment is insoluble or sparingly soluble and the pigment is then treated with sulfamic acid or a complex of sulfur trioxide with a tertiary amine such that the —SO₃M and/or —RSO₂M groups are chemically bonded to the surfaces of the pigment particles.

A single functional group or different types of functional groups may be grafted to each pigment particle. The type of a grafted functional group and the degree of grafting may be appropriately determined in view of the dispersion stability of the pigment in the aqueous ink composition, the color density of the aqueous ink composition, the dryness of the aqueous ink composition present on the front surface of an ink jet head, or the like.

The resin-dispersed pigment, the surfactant-dispersed pigment, or the surface-treated pigment can be dispersed in water using a conventional disperser such as a ball mill, a sand mill, an attritor, a roll mill, an agitator mill, a Henschel mixer, a colloid mill, an ultrasonic homogenizer, a jet mill, or an angmill in such a manner that the pigment, water, and the resin dispersant are mixed together in the case of the resin-dispersed pigment; the pigment, water, and the surfactant are mixed together in the case of the surfactant-dispersed pigment; or the surface-treated pigment and water are mixed together. A water-soluble organic solvent, a neutralizer, or the like may be added to the mixture as required. From the viewpoint of securing the dispersion stability of the pigment in water, the pigment is dispersed in water until the volume-average particle size (hereinafter referred to as average particle size) of the pigment is preferably reduced to the range of 20 nm to 500 nm and more preferably 50 nm to 200 nm. When the pigment has an average particle size of 250 nm or less, the occurrence of clogging can be suppressed and therefore ejection stability can be sufficiently achieved.

### 1.2 Paraffin Wax

The aqueous ink composition, which is used in the ink jet recording method, contains the paraffin wax as described above. The paraffin wax in the aqueous ink composition imparts slippage to a surface of a record to increase the abrasion resistance of the record. Since the paraffin wax is hydrophobic, the use of an appropriate amount of the paraffin wax allows the record to have increased water resistance.

The paraffin wax is so-called a petroleum wax and is a mixture which principally contains a linear paraffinic hydrocarbon (normal paraffin) containing about 20 to 30 carbon atoms and which contains a small amount of an isoparaffinic hydrocarbon with a molecular weight of about 300 to 500.

In the aqueous ink composition, the paraffin wax is preferably in the form of fine particles (that is, in the form of an emulsion or suspension). When the paraffin wax is in the form of fine particles, the viscosity of the aqueous ink composition is readily adjusted to a range suitable for the ink jet recording method and the storage stability and ejection stability of the aqueous ink composition is readily secured. The melting point of the paraffin wax is not particularly limited and is preferably 110° C. or lower. When the melting point of the paraffin wax is higher than 110° C., the record may possibly have a brittle coating and has reduced abrasion resistance in the case of raising the drying temperature of the record to higher than 110° C.

The paraffin wax preferably has a melting point of 60° C. or higher. When the melting point thereof is lower than 60° C., a surface of the record does not become dry and therefore is likely to be sticky. The melting point of the paraffin wax is more preferably 70° C. to 95° C. When the melting point thereof is within this range, the ejection stability of the aqueous ink composition is good.

In the case of using the paraffin wax in the form of fine particles, the paraffin wax preferably has an average particle size of 5 nm to 400 nm and more preferably 50 nm to 200 nm from the viewpoint of securing the storage stability and ejection stability of the aqueous ink composition. The paraffin wax may be a commercial product such as AQUACER 537 or 539 available from Byk Chemie Japan K.K.

The content of the paraffin wax in the aqueous ink composition is preferably 0.1% to 3% by mass and more preferably 0.1% to 1.5% by mass in terms of solid content. When the content of the paraffin wax is within the above range, an image having excellent abrasion resistance, blocking resistance, and water resistance can be formed on an ink non-absorbent or low ink-absorbing recording medium using the aqueous ink composition and the clogging of the aqueous ink composition is well prevented.

### 1.3 Water

The aqueous ink composition, which is used in the ink jet recording method, contains water as described above. Water serves as a main medium in the aqueous ink composition and is a component that is evaporated in a step of heating a recording medium as described below.

The water contained therein is preferably pure or ultra-pure water, such as ion-exchanged water, ultra-filtered water, reverse osmosis-purified water, or distilled water, substantially free of ionic impurities. Water sterilized by ultraviolet irradiation or with hydrogen peroxide is preferably used in a pigment dispersion or the aqueous ink composition because the proliferation of molds and bacteria can be prevented during the long-term storage of the pigment dispersion or the aqueous ink composition.

### 1.4 Resin Particles

The aqueous ink composition, which is used in the ink jet recording method, contains the resin particles in addition to the paraffin wax. The resin particles has the effect of forming a resin coating together with the paraffin wax to fix a print on the recording medium to increase the abrasion resistance in the step of heating the recording medium. Therefore, the resin particles are preferably thermoplastic. This effect allows a record recorded on the ink non-absorbent or low ink-absorbing recording medium using the aqueous ink composition to have excellent abrasion resistance. The resin particles are preferably present in the aqueous ink composition in the form of fine particles (that is, in the form of an emulsion or suspension). When the resin particles are in the form of fine particles, the viscosity of the aqueous ink composition can be readily adjusted to a range suitable for the ink jet recording method and the storage stability and ejection stability of the aqueous ink composition can be readily secured.

Examples of a component of the resin particles include polymers and copolymers of acrylic acid, acrylic esters, methacrylic acid, methacrylic esters, acrylonitrile, cyanoacrylates, acrylamides, olefins, styrene, vinyl acetate, vinyl chloride, vinyl alcohol, vinyl ethers, vinylpyrrolidones, vinylpyridines, vinylcarbazoles, vinylimidazoles, and vinylidene chloride and also include fluorocarbon resins and natural resins. The copolymers may be in the form of random copolymers, block copolymers, alternating copolymers, and graft copolymers. The resin particles are preferably made of a styrene-acrylic acid copolymer resin.

The resin particles can be obtained from a known material by a known process. Examples of such a material include commercial products, such as Microgel E-1002 and Microgel E-5002, available from Nippon Paint Co., Ltd.; commercial products, such as Boncoat 4001 and Boncoat 5454, available from DIC Corporation; a commercial product, such as SAE-1014, available from Zeon Corporation; a commercial product, such as Saivinol SK-200, available from Saiden Chemical Industry Co., Ltd.; and commercial products, such as Joncryl 7100, Joncryl 390, Joncryl 711, Joncryl 511, Joncryl 7001, Joncryl 632, Joncryl 741, Joncryl 450, Joncryl 840, Joncryl 74J, Joncryl HRC-1645J, Joncryl 734, Joncryl 852, Joncryl 7600, Joncryl 775, Joncryl 537J, Joncryl 1535, Joncryl PDX-7630A, Joncryl 352J, Joncryl 352D, Joncryl PDX-7145, Joncryl 538J, Joncryl 7640, Joncryl 7641, Joncryl 631, Joncryl 790, Joncryl 780, and Joncryl 7610, available from BASF Japan Ltd.

The resin particles can be obtained by any one of processes below. The processes may be used in combination as required. The processes are as follows: a process in which a monomer for producing a component of the resin particles is mixed with a polymerization catalyst (polymerization initiator) and a dispersant and is subjected to polymerization (that is, emulsion polymerization); a process in which particles having hydrophilic portions are dissolved in a water-soluble organic solvent, the solution thereby obtained is mixed with water, and the water-soluble organic solvent is then removed from the mixture by distillation or the like, whereby the resin particles are obtained; and a process in which particles made of resin are dissolved in a water-insoluble organic solvent and the solution thereby obtained is mixed with a dispersant and an aqueous solution, whereby the resin particles are obtained. The processes can be appropriately selected depending on the type and properties of the resin particles.

A dispersant useful in finely dispersing the resin particles is not particularly limited. Examples of such a dispersant include anionic surfactants such as sodium dodecylbenzenesulfonate, sodium laurylphosphonate, and polyoxyethylene alkyl ether sulfate ammonium salts and nonionic surfactants such as polyoxyethylene alkyl ethers, polyoxyethylene alkyl esters, polyoxyethylene sorbitan fatty acid esters, and polyoxyethylene alkylphenyl ethers. These surfactants may be used alone or in combination.

The reason why a print prepared using the resin particles and the paraffin wax has good abrasion resistance is probably as described below. A component of the resin particles has good affinity to ink non-absorbent or low ink-absorbing recording media and the water-insoluble colorant. Therefore, in the course of forming the resin coating in the step of heating the recording medium, the resin coating is tightly fixed on the recording medium with the water-insoluble colorant covered with the resin coating. A component of the paraffin wax is present on the resin coating and has a function of reducing the frictional resistance of the resin coating. Therefore, the resin coating can be formed so as to hardly wear down due to external friction and so as to be rarely peeled off from the recording medium. This probably allows the print to have increased abrasion resistance.

The resin particles preferably have an average size of 5 nm to 400 nm and more preferably 20 nm to 300 nm from the viewpoint of securing the storage stability and ejection stability of the aqueous ink composition.

The content of the resin particles in the aqueous ink composition is preferably 15% by mass or less and more preferably 0.2% to 10% by mass in terms of solid content. When the content thereof is within this range, the aqueous ink composition can be solidified and fixed on ink non-absorbent or low ink-absorbing recording media. When the content thereof is more than 15% by mass, the storage stability and ejection stability of the aqueous ink composition cannot be secured in some cases.

### 1.5 Other Preferred Components

The aqueous ink composition, which is used in the ink jet recording method, contains the water-insoluble colorant, the paraffin wax, the resin particles, and water as described above. This configuration allows images having excellent abrasion resistance to be printed even on ink non-absorbent or low ink-absorbing recording media. The aqueous ink composition may further content various materials below so as to have enhanced properties.

### 1.5.1 1,2-Alkanediols Containing Five to Seven Carbon Atoms

The aqueous ink composition, which is used in the ink jet recording method, preferably further contains 1,2-alkanediols containing five to seven carbon atoms (hereinafter referred to as “C5-7 1,2-alkanediols” in some cases).

The C5-7 1,2-alkanediols have the effect of enhancing the wettability of the aqueous ink composition to recording media to uniformly wet the recording media and the effect of enhancing the permeability of the aqueous ink composition. When the aqueous ink composition contains the C5-7 1,2-alkanediols, ghost and blur due to the aqueous ink composition can be suppressed.

Examples of the C5-7 1,2-alkanediols include 1,2-pentanediol, 1,2-hexanediol, 1,2-heptanediol, and 4-methyl-1,2-pentanediol.

The content of the C5-7 1,2-alkanediols in the aqueous ink composition is preferably 0.5% to 20% by mass and more preferably 1% to 8% by mass from the viewpoint of securing the storage stability and ejection stability of the aqueous ink composition. When the content of the C5-7 1,2-alkanediols is less than 0.5% by mass, the aqueous ink composition has low wettability to recording media and therefore prints may possibly have ghost or blur. When the content thereof is more than 20% by mass, it is difficult to adjust the viscosity of the aqueous ink composition to a range suitable for the ink jet recording method; hence, the ejection of the aqueous ink composition may possibly become unstable or it may possibly be difficult to secure the long-term storage stability of the aqueous ink composition.

### 1.5.2 Wax

The aqueous ink composition, which is used in the ink jet recording method, may further contain wax other than the paraffin wax. The wax, as well as the paraffin wax, has a function of imparting slippage to a surface of a record to increase the abrasion resistance of the record. The wax is preferably in the form of fine particles (that is, in the form of an emulsion or suspension). When the paraffin wax is in the form of fine particles, the viscosity of the aqueous ink composition is readily adjusted to a range suitable for the ink jet recording method and the storage stability and ejection stability of the aqueous ink composition is readily secured.

The wax is, for example, a polyolefin wax. In particular, the wax is preferably a polyethylene wax or a polypropylene wax. The polyethylene wax is preferred. Examples of the wax include commercial products such as Nopcoat PEM-17 available from San Nopco, Ltd., Chemipearl W4005 available from Mitsui Chemicals, Inc., AQUACER 515, and AQUACER 593 available from BYK Chemie Japan K.K.

The wax preferably has an average particle size of 5 nm to 400 nm and more preferably 50 nm to 200 nm from the viewpoint of securing the storage stability and ejection stability of the aqueous ink composition.

The content of the wax in the aqueous ink composition is preferably 5% by mass or less and more preferably 0.1% to 2% by mass in terms of solid content. When the content thereof is within this range, the aqueous ink composition can be solidified and fixed on ink non-absorbent or low ink-absorbing recording media. When the content thereof is more than 5% by mass, the storage stability and ejection stability of the aqueous ink composition cannot be secured in some cases.

### 1.5.3 Nonionic Surfactant

The aqueous ink composition, which is used in the ink jet recording method, preferably further contains a nonionic surfactant. The nonionic surfactant has a function of uniformly spreading the aqueous ink composition on recording media. When the aqueous ink composition contains the nonionic surfactant, the use of the aqueous ink composition is effective in obtaining a clear image free of ghost and blur. Examples of the nonionic surfactant include polyoxyethylene alkyl ether surfactants, polyoxypropylene alkyl ether surfactants, polycyclic phenyl ether surfactants, sorbitan derivatives, fluorinated surfactants, silicone surfactants, and acetylene glycol surfactants. In particular, the silicone surfactants and the acetylene glycol surfactants are preferred because the silicone surfactants and the acetylene glycol surfactants are excellent in the above effect and have good compatibility and synergy with the C5-7 1,2-alkanediols.

### 1.5.3.1 Silicone Surfactant

The aqueous ink composition, which is used in the ink jet recording method, preferably contains a silicon surfactant. The silicon surfactant is superior in uniformly spreading the aqueous ink composition on recording media without causing ghost or blur as compared with other nonionic surfactants. The silicon surfactant has good compatibility and synergy with the C5-7 1,2-alkanediols. The content of the silicon surfactant in the aqueous ink composition is 1.5% by mass or less. When the content of the silicon surfactant is more than 1.5% by mass, the storage stability or ejection stability of the aqueous ink composition cannot be secured in some cases.

The silicon surfactant is preferably a polysiloxane compound, of which an example is a polyether-modified organosiloxane. Examples of the silicon surfactant include surfactants, such as BYK-306, BYK-307, BYK-333, BYK-341, BYK-345, BYK-346, and BYK-348, available from Byk Chemie Japan K.K. and surfactants, such as KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017, available from Shin-Etsu Chemical Co., Ltd.

### 1.5.3.2 Acetylene Glycol Surfactant

The aqueous ink composition, which is used in the ink jet recording method, preferably contains an acetylene glycol surfactant. The acetylene glycol surfactant is superior in appropriately maintaining the surface tension or interfacial tension of the aqueous ink composition as compared with other nonionic surfactants and is characteristic of having substantially no foaming power. Therefore, when the aqueous ink composition contains the acetylene glycol surfactant, the aqueous ink composition can appropriately maintain the interfacial tension between the aqueous ink composition and a printer member, such as a head nozzle, in contact with the aqueous ink composition. Thus, in the case of applying the aqueous ink composition to the ink jet recording method, ejection stability can be enhanced. The acetylene glycol surfactant, as well as the C5-7 1,2-alkanediols, has good wettability to recording media and acts as a penetrant. Therefore, when the aqueous ink composition contains the acetylene glycol surfactant, an image printed with the aqueous ink composition is free of ghost and blur and has high density. The content of the acetylene glycol surfactant in the aqueous ink composition is preferably 1.0% or less. When the content of the acetylene glycol surfactant is more than 1.0% by mass, the storage stability or ejection stability of the aqueous ink composition cannot be secured in some cases.

Examples of the acetylene glycol surfactant include surfactants, such as Surfynol 104, Surfynol 104E, Surfynol 104H, Surfynol 104A, Surfynol 104BC, Surfynol 104DPM, Surfynol 104PA, Surfynol 104PG-50, Surfynol 104S, Surfynol 420, Surfynol 440, Surfynol 465, Surfynol 485, Surfynol SE, Surfynol SE-F, Surfynol 504, Surfynol 61, Surfynol DF37, Surfynol CT 111, Surfynol CT 121, Surfynol CT 131, Surfynol CT 136, Surfynol TG, Surfynol GA, and Surfynol DF 110D, available from Air Products and Chemicals, Inc.; surfactants, such as Olfine B, Olfine Y, Olfine P, Olfine A, Olfine STG, Olfine SPC, Olfine E1004, Olfine E1010, Olfine PD-001, Olfine PD-002W, Olfine PD-003, Olfine PD-004, Olfine EXP. 4001, Olfine EXP. 4036, Olfine EXP. 4051, Olfine AF-103, Olfine AF-104, Olfine AK-02, Olfine SK-14, and Olfine AE-3, available from Nissin Chemical Industry Co., Ltd.; and surfactants, such as Acetylenol E00, Acetylenol E00P, Acetylenol E40, and Acetylenol E100, available from Kawaken Fine Chemicals Co., Ltd.

### 1.5.4 Pyrrolidone Derivative

The aqueous ink composition, which is used in the ink jet recording method, preferably contains a pyrrolidone derivative. The pyrrolidone derivative acts as a good solubilizer or softener for the resin particles to facilitate the formation of a coating from the resin particles during the drying of the aqueous ink composition and has a function of facilitating the solidification and fixation of the aqueous ink composition on ink non-absorbent or low ink-absorbing recording media. The content of the pyrrolidone derivative in the aqueous ink composition is 5% to 25% by mass. When the content of the pyrrolidone derivative is less than 5% by mass, the action of dissolving or softening the resin particles is insufficient.

Examples of the pyrrolidone derivative include low-molecular weight compounds such as N-methyl-2-pyrrolidone, N-ethyl-2-pyrrolidone, N-vinyl-2-pyrrolidone, 2-pyrrolidone, N-butyl-2-pyrrolidone, and 5-methyl-2-pyrrolidone. In particular, 2-pyrrolidone and N-methyl-2-pyrrolidone are preferred from the viewpoint of securing the storage stability of the aqueous ink composition, the viewpoint of facilitating the formation of a coating from the resin particles, and the viewpoint of having a relatively weak odor. The pyrrolidone derivative is a preferred solvent and a lactone solvent such as γ-butyrolactone or a sulfoxide solvent such as dimethylsulfoxide may be used instead.

### 1.5.5 Another Solvent

The aqueous ink composition, which is used in the ink jet recording method, may further contain a solvent having moisture retentivity or low surface tension. Examples of such a solvent include water-soluble solvents such as ethylene glycol, diethylene glycol, triethylene glycol, propylene glycol, dipropylene glycol, 1,3-propanediol, 1,4-butanediol, 1,5-pentanediol, 1,6-hexanediol, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, diethylene glycol dimethyl ether, diethylene glycol diethyl ether, diethylene glycol dibutyl ether, diethylene glycol ethyl methyl ether, diethylene glycol butyl methyl ether, triethylene glycol dimethyl ether, tetraethylene glycol dimethyl ether, dipropylene glycol dimethyl ether, dipropylene glycol diethyl ether, tripropylene glycol dimethyl ether, methanol, ethanol, n-propanol, iso-propanol, 2,2-dimethyl-1-propanol, n-butanol, 2-butanol, tert-butanol, iso-butanol, 2-methyl-1-butanol, 3-methyl-1-butanol, 3-methyl-2-butanol, n-pentanol, 2-pentanol, 3-pentanol, and tert-pentanol.

### 1.5.6 Other Additives

The aqueous ink composition, which is used in the ink jet recording method, may further contain a pH adjustor, an antiseptic/fungicidal agent, a rust preventive, a chelating agent, and the like.

Examples of the pH adjustor include potassium dihydrogen phosphate, disodium hydrogen phosphate, sodium hydroxide, lithium hydroxide, potassium hydroxide, ammonia, diethanolamine, triethanolamine, triisopropanolamine, potassium carbonate, sodium carbonate, and sodium hydrogen carbonate.

Examples of the antiseptic/fungicidal agent include sodium benzoate; sodium pentachlorophenolate; sodium 2-pyridinethiol-1-oxide; sodium sorbate; sodium dehydroacetate; 1,2-dibenzothiazoline-3-on; commercial products, such as Proxel XL2 and Proxel GXL, available from Avecia K.K.; and commercial products, such as Denicide CSA and Denicide NS-500W, Nagase ChemteX Corporation.

An example of the rust preventive is benzotriazole.

Examples of the chelating agent include ethylenediaminetetraacetic acid and ethylenediaminetetraacetates such as disodium dihydrogen ethylenediaminetetraacetate.

Low ink-absorbing and ink non-absorbent recording media are unlikely to be impregnated with ink and therefore the aqueous ink composition applied thereto is unlikely to be dried in some cases. Therefore, the aqueous ink composition is preferably substantially free of an alkanepolyol with a boiling point of 280° C. or higher at 1 atm such that the aqueous ink composition applied to the low ink-absorbing and ink non-absorbent recording media is readily dried. The term “substantially free of an alkanepolyol” as used herein means that the content of an alkanepolyol in, for example, ink preferably does not exceed 0.1% by mass, more preferably 0.05% by mass, and further more preferably 0.01% by mass. A typical example of the alkanepolyol with a boiling point of 280° C. or higher at 1 atm is glycerin, which has a boiling point of 290° C.

### 1.6 Properties of Aqueous Ink Composition

The aqueous ink composition preferably has a viscosity of 1.5 mPa·s to 15 mPa·s at 20° C. When the viscosity thereof is within this range, the ejection stability of the aqueous ink composition can be secured in a first step below. The viscosity of the aqueous ink composition can be measured with a vibratory viscometer, VM-100AL, Yamaichi Electronics Co., Ltd. in such a manner that the temperature of the aqueous ink composition is maintained at 20° C.

The aqueous ink composition preferably has a surface tension of 20 mN/m to 40 mN/m and more preferably 25 mN/m to 35 mN/m at 25° C. When the surface tension thereof is within this range, the ejection stability of the aqueous ink composition can be secured in the first step and the wettability of the aqueous ink composition to ink non-absorbent or low ink-absorbing recording media can be appropriately secured. The surface tension of the aqueous ink composition can be measured with a surface tensiometer, CBVP-Z, available from Kyowa Interface Science Co., Ltd.

### 1.7 Process for Producing Aqueous Ink Composition

The aqueous ink composition can be produced in such a manner that the above components are mixed in an arbitrary order and impurities are removed by filtration as required. Because of ease in handling, the water-insoluble colorant is preferably used in such a state that the water-insoluble colorant is uniformly dispersed in water.

A technique for mixing the components is preferably as follows: the components are sequentially put into a vessel equipped with a stirrer such as a mechanical stirrer or a magnetic stirrer and are then mixed together. A filtering technique such as centrifugal filtration or filter filtration can be used as required.

### 2. Ink Jet Recording Method

Exemplary steps of the ink jet recording method are described below in detail. The ink jet recording method includes a first step of ejecting droplets of the aqueous ink composition to form an image on a recording medium and a second step of heating the recording medium.

### 2.1 First Step

In the ink jet recording method, the first step is a step of ejecting the aqueous ink composition droplets to form the image on the recording medium. In the first step, the recording medium is heated to a temperature of 40° C. to 80° C. with a print heater or the like attached to an ink jet recording apparatus and the aqueous ink composition droplets are ejected toward the recording medium. Every known ink jet ejecting process can be used herein. In particular, a process for ejecting droplets using the vibration of a piezoelectric element, that is, a recording process using an ink jet head for forming ink droplets by the mechanical distortion of an electrostrictive element is capable of recording an excellent image. The term “heating temperature” as used herein refers to the surface temperature of a recording medium in contact with the aqueous ink composition.

### 2.2 Second Step

In the second step, the recording medium having the image is heated to a temperature of 50° C. to 110° C. with a hot-air blower attached to the ink jet recording apparatus or a dryer, such as a thermostatic chamber, connected to the ink jet recording apparatus and thereby the aqueous ink composition applied onto the recording medium is dried. The second step is not limited to a step of heating the recording medium after recording and may be a step of heating the recording medium before or during recording.

In the case of heating an ink non-absorbent or low ink-absorbing recording medium to a temperature of 40° C. to 80° C., a high-quality image free of ghost and blur can be formed on the ink non-absorbent or low ink-absorbing recording medium by ejecting droplets of the aqueous ink composition in the first step. Therefore, the first step preferably includes heating.

In the second step, in which the recording medium having the image is heated to a temperature of 50° C. to 110° C., the water contained in the aqueous ink composition applied onto the recording medium is quickly evaporated and a coating is formed from the resin particles, which are contained in the aqueous ink composition. This allows the dry matter of the aqueous ink composition to be tightly bonded to the recording medium, thereby obtaining a high-quality image free of ghost and blur in a short time. The heating temperature of the recording medium is preferably appropriately adjusted depending on the heat resistance of the recording medium within the range of 40° C. to 80° C. in the first step or within the range of 50° C. to 110° C. in the second step. In the first step, the recording medium is preferably heated during the recording of the image. In the second step, the recording medium is preferably heated in the thermostatic chamber or with the hot-air blower after the recording of the image.

The evaporation of a solvent in the aqueous ink composition can be facilitated by setting the heating temperature to 50° C. or higher in the second step. An increase in the heating temperature in the second step is advantageous for the dryness and abrasion resistance of the aqueous ink composition. However, when the heating temperature of the recording medium is higher than 110° C., the recording medium is deformed depending on the type of the recording medium or failures such as the shrinkage of the recorded image occur during the heating or cooling the recording medium in some cases. Furthermore, there are problems such as the increase in power consumption of a heater used to heat the recording medium and the increase of heat emitted from an ink jet printer including the heater. Therefore, the upper limit of the heating temperature of the recording medium is preferably 110° C.

When the recording medium is made of polyvinyl chloride and therefore is likely to be deformed at elevated temperature, the recording medium is preferably heated at 60° C. or lower in the first step. When the heating temperature in the first step is higher than 60° C., the recording medium made of polyvinyl chloride is rapidly softened and is likely to be deformed; hence, it is difficult to transport the recording medium in the ink jet recording apparatus in some cases. When the heating temperature in the second step is lower than 50° C., a solvent contained in the aqueous ink composition remains in the recorded image and therefore a water-insoluble coating is insufficiently formed from the resin particles; hence, the strength of the is insufficient in some cases. The heating temperature in the second step is preferably higher than the heating temperature in the first step.

The recording medium may be of any type. In the invention, the recording medium is an ink non-absorbent or low ink-absorbing recording medium. Examples of the ink non-absorbent recording medium include plastic films having untreated surfaces for ink jet printing (that is, plastic films having no ink-absorbing layers); substrates, made of paper, having plastic coatings thereon; and substrates equipped with plastic films. The term “plastic” as used herein includes polyvinyl chloride, polyethylene terephthalate, polycarbonate, polystyrene, polyurethane, polyethylene, and polypropylene. Examples of the low ink-absorbing recording medium include printing paper sheets such as art paper sheets, coated paper sheets, and matte paper sheets.

The term “ink non-absorbent or low ink-absorbing recording medium” as used herein refers to a recording medium that absorbs 10 mL/m² or less water for a contact time of 30 msec1/2 as determined by a Bristow method. The Bristow method is the most widely used method for measuring the amount of liquid absorbed in a short time. The Bristow method has been adopted by Japan Technical Association of the Pulp and Paper Industry (JAPAN TAPPI). Details of the Bristow method are described in Standard No. 51 “Kami Oyobi Itagami-Ekitai Kyushusei Siken Houhou-Buristo Hou (Paper and paperboard-liquid absorption test method-Bristow method)” in “JAPAN TAPPI Paper and Pulp Test Methods, 2000 Edition”.

### 3. Examples

The invention is further described below in detail with reference to examples. The invention is not limited to the examples.

### 3.1.1 Preparation of Pigment Dispersions

Water-insoluble colorants used to prepare aqueous ink compositions in the examples were pigments. In particular, pigment dispersions prepared by dispersing the pigments with resin dispersants were used to prepare the aqueous ink compositions. Each pigment dispersion was prepared as described below.

To a mixture of seven parts by mass potassium hydroxide, 23 parts by mass water, and 30 parts by mass triethylene glycol mono-n-butyl ether, 40 parts by mass of a polymeric dispersant, prepared by copolymerizing methacrylic acid, butyl acrylate, styrene, and hydroxyethyl acrylate at a mass ratio of 25:50:15:10, having a weight-average molecular weight of 12,000 was added, followed by heating at 80° C., mixing, and polarization, whereby a polymeric dispersant varnish with a solid content of 43% was obtained. To 2.4 kg of the polymeric dispersant varnish, 3.0 kg of one of the pigments, 1.5 kg ethylene glycol, and 8.1 kg water were added, followed by premixing in a mixer, whereby a pigment dispersion mixture was obtained. The pigment dispersion mixture was treated in a horizontal bead mill which was filled with zirconia beads with a size of 0.5 mm up to 85% of the volume thereof, which had an effective volume of 1.5 L, and which was equipped with a multi-disk impeller in a multi-path way. In particular, the pigment dispersion mixture was treated at a bead peripheral speed of 8 m/s and a discharge rate of 30 L/h using two paths. The resulting pigment dispersion mixture had an average particle size of 325 nm. The pigment dispersion mixture was circularly treated in a horizontal annular bead mill which as filled with zirconia beads with a size of 0.05 mm up to 95% of the volume thereof and which had an effective volume of 1.5 L. In particular, 10 kg of the pigment dispersion mixture was treated at a bead peripheral speed of 10 m/s and a circulation rate of 300 L/h for four hours using a screen with 0.015 mm openings, whereby the pigment dispersion was obtained. The pigments used were as follows: C. I. Pigment Black 7, which was used to prepare a black pigment dispersion; C. I. Pigment Yellow 74, which was used to prepare a yellow pigment dispersion; C. I. Pigment Red 122, which was used to prepare a red pigment dispersion; and C. I. Pigment Blue 15:3, which was used to prepare a cyan pigment dispersion.

### 3.1.2 Preparation of Aqueous Ink Compositions

The aqueous ink compositions were prepared using the pigment dispersions, which were prepared as described above in Section “3.1.1 Preparation of pigment dispersions”, and different materials so as to have compositions shown in Table 1 and so as to each have a corresponding one of four colors: black, yellow, magenta, and cyan. In particular, each aqueous ink composition was prepared in such a manner that materials shown in Table 1 were put into a vessel and were mixed together with a magnetic stirrer for two hours and the mixture thereby obtained was filtered through a membrane filter with a pore size of 5 μm, whereby dust and impurities such as coarse particles were removed from the mixture. Values shown in Table 1 are on a mass percent basis. Ion-exchanged water was added to the mixture such that the sum of the contents of all components of the aqueous ink composition is 100% by mass. Resin particles shown in Table 1 were made of a styrene-acrylic acid copolymer with a glass transition temperature of 85° C. A surfactant shown in Table 1 was a silicone surfactant, BYK-348, available from Byk Chemie Japan K.K. The average particle size of AQUACER 539 (AQ539) shown in Table 1 was 54 nm. The average particle size of AQUACER 537 (AQ537) shown in Table 1 was 33 nm. The average particle size of SELOSOL H-620 (SELOSOL) shown in Table 1 was 200 nm. A polyethylene wax used was AQUACER 515, having a melting point of 135° C. and average particle size of 60 nm, available from Byk Chemie Japan K.K.

TABLE 1

| | | | | | | | | | | | Compar- | Compar- | Compar- |
|---|---|---|---|---|---|---|---|---|---|---|---|---|---|
| | | Ex- | Ex- | Ex- | Ex- | Ex- | Ex- | Ex- | Ex- | Ex- | ative | ative | ative |
| | | ample | ample | ample | ample | ample | ample | ample | ample | ample | Ex- | Ex- | Ex- |
| Components | | 1 | 2 | 3 | 4 | 5 | 6 | 7 | 8 | 9 | ample 1 | ample 2 | ample 3 |
| Pigment | | C | C | C | C | C | C | Y | K | M | C | C | C |
| Pigment content | | 4 | 4 | 4 | 4 | 4 | 4 | 5 | 5 | 4 | 4 | 4 | 4 |
| (solid content) | | | | | | | | | | | | | |
| 1,2-hexane diol | | 4 | 3 | 3 | 3 | 4 | 4 | 4 | 3 | 3 | 3 | 3 | 3 |
| 2-pyrrolidone | | 15 | 15 | 15 | 15 | 15 | 15 | 15 | 15 | 15 | 15 | 15 | 15 |
| Surfactant | Silicone surfactant | 0.5 | 0.5 | 0.5 | 0.5 | 0.5 | 0.5 | 0.5 | 0.5 | 0.5 | 0.5 | 0.5 | 0.5 |
| Water-soluble resin | Styrene-acrylic | 1 | 1 | 1 | 1 | 1 | 1 | 1 | 1 | 1 | 1 | 1 | 1 |
| (solid content) | acid copolymer | | | | | | | | | | | | |
| Paraffin wax | A (melting point | 0.1 | 3 | | | 1.5 | 1.5 | 2 | 1.5 | 1.5 | | 5 | 1.5 |
| (solid content) | of 90° C.) | | | | | | | | | | | | |
| | AQ539 | | | | | | | | | | | | |
| | Byk Chemie | | | | | | | | | | | | |
| | B (melting point | | | 1.5 | | | | | | | | | |
| | of 110° C.) | | | | | | | | | | | | |
| | AQ537 | | | | | | | | | | | | |
| | Byk Chemie | | | | | | | | | | | | |
| | C (melting point | | | | 1.5 | | | | | | | | |
| | of 68° C.) | | | | | | | | | | | | |
| | SELOSOL | | | | | | | | | | | | |
| | Chukyo Yushi | | | | | | | | | | | | |
| Resin particles | Resin emulsion | 2 | 2 | 2 | 2 | 2 | 2 | 2 | 2 | 2 | 2 | 2 | |
| (solid content) | (styrene-acrylic | | | | | | | | | | | | |
| | acid copolymer) | | | | | | | | | | | | |
| Polyethylene wax | AQ515 | 0.2 | 0.2 | 0.2 | 0.2 | 0.2 | | | 0.4 | 0.3 | 0.2 | 0.2 | 0.2 |
| (solid content) | Byk Chemie | | | | | | | | | | | | |

| | |
|---|---|
| Pure water | Balance |

### 3.2 Evaluation of Aqueous Ink Compositions

A printer, PX-G930, available from Seiko Epson Corporation was partly modified so as to be capable of heat a recording medium during recording and was used to evaluate the aqueous ink compositions, which were prepared in the examples and comparative examples.

In evaluations below, each sample was prepared by ink jet recording so as to have a vertical resolution of 720 dpi and a horizontal resolution of 720 dpi.

1. Abrasion Resistance

Recording media below were heated at 45° C. during recording, were dried at 60° C. for one minute after recording, were left at room temperature for six hours, and were then checked for abrasion resistance.

### Recording Media

(1) Polyvinyl chloride films, LLSP EX113, available from Sakurai Co., Ltd.

(2) Cold laminate films, PG-50L, available from Lami Corporation Inc.

Recording surfaces of the recording media were rubbed with cotton cloth 100 times at a load of 500 g using a Gakushin-type rubbing fastness tester, were visually checked whether the recording surfaces had scratches or not, and were evaluated in accordance with standards below.

### Evaluation Standards

A: no scratches

B: slight scratches

C: scratches

D: large scratches

2. Blocking Resistance

Recording media below were heated at 45° C. during recording, were dried at 60° C. for one minute after recording, were left at room temperature for six hours, and were then tested for blocking resistance by a procedure below.

### Recording Media

Polyvinyl chloride films, LLSP EX113, available from Sakurai Co., Ltd.

Each recorded recording media was laminated with a corresponding one of the unrecorded recording media such that a recording surface of the recorded recording medium was in contact with a recording surface of the unrecorded recording medium. The laminate thereby obtained was loaded with 10 kg per 100 cm² and was left for 24 hours in a 50° C. atmosphere with a relative humidity of 80%. The recorded recording media was stripped from the unrecorded recording media, was observed for condition, and was then evaluated in accordance with standards below.

### Evaluation Standards

A: no blocking

B: partial blocking

3. Water Resistance

Recording media below were heated at 45° C. during recording, were dried at 60° C. for one minute after recording, and were then tested for water resistance by a procedure below.

### Recording Media

Polyvinyl chloride films, LLSP EX113, available from Sakurai Co., Ltd.

To a recording surface of each recording medium, droplets of 1 mL tap water were applied. The water droplets were removed from the recording surface by wiping the recording surface with cotton cloth three times. The wiped recording surface and the cotton cloth were visually observed and were evaluated in accordance with standards below.

### Evaluation Standards

A: no ink (colorant) removed from a recording medium or no colored cotton cloth

B: ink (colorant) partly removed from a recording medium and colored cotton cloth

4. Ejection Stability

The aqueous ink compositions, which were prepared in the example and the comparative examples, were each filled in a corresponding one of cartridges. Each cartridge was attached to the above printer and was used for continuous recording for ten minutes without heating, thereby confirming that all nozzles worked properly. Subsequently, the cartridge was used for continuous recording at 45° C. An obtained record was checked whether there was any dot defect or skew or not and was then evaluated in accordance with standards below.

### Evaluation Standards

A: no dot defect or skew after an elapse of two hours

B: no dot defect or skew after an elapse of one hour

C: a slight skew after an elapse of one hour

D: a dot defect and a skew after an elapse of one hour

The evaluation results are as shown in Table 2.

TABLE 2

| | | | | | | | | | | Compar- | Compar- | Compar- |
|---|---|---|---|---|---|---|---|---|---|---|---|---|
| | | Ex- | Ex- | Ex- | Ex- | Ex- | Ex- | Ex- | Ex- | ative | ative | ative |
| | | ample | ample | ample | ample | ample | ample | ample | ample | Ex- | Ex- | Ex- |
| Examples | | 1 | 2 | 3 | 4 | 5 | 6 | 7 | 8 | ample 1 | ample 2 | ample 3 |
| 1. Abrasion | Medium: polyvinyl | BC | B | B | B | BC | B | B | B | D | C | D |
| resistance | chloride | | | | | | | | | | | |
| | Medium: PET | B | B | B | B | B | B | B | B | B | C | B |
| 2. Blocking | Medium: polyvinyl | B | B | B | B | B | B | B | B | B | D | B |
| resistance | chloride | | | | | | | | | | | |
| 3. Water | Medium: polyvinyl | B | B | B | B | B | B | B | B | B | D | B |
| resistance | chloride | | | | | | | | | | | |
| 4. Ejection | | B | BC | A | B | B | B | B | B | B | D | B |
| stability | | | | | | | | | | | | |

As is clear from Table 2, the aqueous ink compositions containing the paraffin wax and the resin particles are excellent in abrasion resistance. A paraffin wax content of 0.1% to 3% by mass is sufficient for practical use in abrasion resistance, blocking resistance, water resistance, and ejection stability.

What is claimed is:

1. An ink jet recording method comprising:
heating an ink non-absorbent or low ink-absorbing recording medium to a temperature of 40° C. to 110° C.; and
performing recording using an aqueous ink composition containing a water-insoluble colorant, a paraffin wax, resin particles, and water.

2. The ink jet recording method according to claim 1, wherein the paraffin wax has an average particle size of 5 nm to 400 nm.

3. The ink jet recording method according to claim 1, wherein the paraffin wax has a melting point of 110° C. or lower.

4. The ink jet recording method according to claim 1, wherein the content of the paraffin wax in the aqueous ink composition is 0.1% to 3% by mass.

5. The ink jet recording method according to claim 1, wherein the recording medium is made of polyvinyl chloride.

6. The ink jet recording method according to claim 1, wherein the aqueous ink composition further contains a polyethylene wax.

7. The ink jet recording method according to claim 1, wherein the aqueous ink composition is substantially free of an alkanepolyol with a boiling point of 280° C. or higher at 1 atm.

8. An ink composition used in the ink jet recording method according to claim 1.

9. A record recorded by the ink jet recording method according to claim 1.

10. A recording apparatus using the ink jet recording method according to claim 1.

11. An aqueous ink composition applied to an ink non-absorbent or low ink-absorbing recording medium heated to a temperature of 40° C. to 110° C., the aqueous ink composition containing:
a water-insoluble colorant;
a paraffin wax;
resin particles; and
water.
